(19) United States
(12) Patent Application Publication
(10) Pub. No.: US 2020/0028450 A1
(43) Pub. Date: Jan. 23, 2020

(54) TRIBOELECTRIC GENERATOR

(71) Applicant: Lintec of America, Inc., Richardson, TX (US)

(72) Inventor: Jaeah Lee, Richardson, TX (US)

(73) Assignee: Lintec of America, Inc., Richardson, TX (US)

(21) Appl. No.: 16/458,580

(22) Filed: Jul. 1, 2019

Related U.S. Application Data
(60) Provisional application No. 62/700,414, filed on Jul. 19, 2018.

(51) Int. Cl. H02N 1/04; D06M 15/19; D06M 15/233

(52) U.S. Cl. CPC H02N 1/04; D06M 15/233; D06M 15/195

(57) ABSTRACT

A triboelectric generator includes a set of two triboelectric elements. A first triboelectric element includes a nanofiber sheet and a coating of a first material having a positive triboelectric affinity. A second triboelectric element includes a nanofiber sheet and a coating of a second material having a negative triboelectric affinity. The first and second triboelectric elements are arranged so that confronting surfaces of the elements can reversibly contact one another. Repeated contact between the two triboelectric elements can transfer electrons and thus generate electrical energy. In some examples, a plurality of sets of first and second triboelectric elements can be arranged to increase surface area of contact between elements, and thus the amount of electrical energy produced per unit time.

### TECHNICAL FIELD

The present disclosure relates generally to energy production. Specifically, the present disclosure relates to a triboelectric generator.

### BACKGROUND

The triboelectric electric effect describes the phenomenon of generating an electrical charge when contacting two different, complementary materials together. Various materials have been characterized for their triboelectric “affinity.” The relative affinities for different materials can be found in various published “triboelectric series.” Generally, materials are characterized within the triboelectric series as either having a positive triboelectric affinity value or a negative triboelectric affinity value. Positive triboelectric affinity materials generally donate electrons and negative triboelectric affinity materials generally accept electrons. When oppositely signed affinity materials are placed in contact, an electrical charge develops. The further apart materials are from one another within the triboelectric series, the more charge is generated when contacting the materials.

### SUMMARY

Example 1 is a set of triboelectric elements comprising: a first triboelectric element that includes: a first nanofiber sheet having opposing major surfaces; a layer of a first material on at least one of the opposing major surfaces of the first nanofiber sheet, the first material having a positive triboelectric affinity; a second triboelectric element that includes: a second nanofiber sheet having opposing major surfaces; a layer of a second material on at least one of the opposing major surfaces of the second nanofiber sheet, the second material having a negative triboelectric affinity; and a resilient connection between the first triboelectric element and the second triboelectric element, wherein the layer of the first material of the first triboelectric element and the layer of the second material of the second triboelectric element are opposed to one another.

Example 2 includes the subject matter of Example 1, wherein the resilient connection between the first triboelectric element and the second triboelectric element comprises a spring at a first common end of the first triboelectric element and the second triboelectric element.

Example 3 includes the subject matter of Example 2, further comprising a pivot structure at a second comment end of the first triboelectric element and the second triboelectric element opposite the first common end.

Example 4 includes the subject matter of Example 3, wherein the pivot structure comprises a hinge.

Example 5 includes the subject matter of any of the preceding Examples, further comprising an electrically conductive material disposed within at least one of the first nanofiber sheet and the second nanofiber sheet.

Example 6 includes the subject matter of Example 5, further comprising an electrically conductive material disposed within at least one of the first nanofiber sheet and the second nanofiber sheet.

Example 7 includes the subject matter of Example 5, wherein the electrically conductive material is poly(3,4-ethylenedioxythiophene) polystyrene sulfonate.

Example 8 includes the subject matter of Example 7, wherein the poly(3,4-ethylenedioxythiophene) polystyrene sulfonate is sulfuric acid modified poly(3,4-ethylenedioxythiophene) polystyrene sulfonate.

Example 9 is a triboelectric element comprising: a nanofiber sheet having two opposite major surfaces; and a material having a triboelectric affinity disposed on at least one of the major surfaces.

Example 10 includes the subject matter of Example 9, wherein the material having a triboelectric affinity is a first material having a positive triboelectric affinity.

Example 11 includes the subject matter of Example 9, wherein the material having a triboelectric affinity is a second material having a negative triboelectric affinity.

Example 12 includes the subject matter of any of Examples 9-11, further comprising an electrically conductive material disposed between nanofibers within the nanofiber sheet.

Example 13 includes the subject matter of Example 12, wherein the electrically conductive material is poly(3,4-ethylenedioxythiophene) polystyrene sulfonate.

Example 14 includes the subject matter of Example 13, wherein the poly(3,4-ethylenedioxythiophene) polystyrene sulfonate is sulfuric acid modified poly(3,4-ethylenedioxythiophene) polystyrene sulfonate.

Example 15 is a triboelectric generator assembly comprising: a first set of triboelectric elements, the first set comprising: a first triboelectric element that includes a first nanofiber sheet having opposing major surfaces, a layer of a first material on at least one of the opposing major surfaces of the first nanofiber sheet, the first material having a positive triboelectric affinity; a second triboelectric element that includes a second nanofiber sheet having opposing major surfaces, a layer of a second material on at least one of the opposing major surfaces of the second nanofiber sheet, the second material having a negative triboelectric affinity; a resilient connection between the first triboelectric element and the second triboelectric element, wherein the first triboelectric element and the second triboelectric element are configured so that the layer of the first material in the layer of the second material are configured to be brought into reversible contact with one another; and a second set of triboelectric elements, the second set comprising: a third triboelectric element that includes a third nanofiber sheet having opposing major surfaces, a layer of the first material on at least one of the opposing major surfaces of the third nanofiber sheet; a fourth triboelectric element that includes a fourth nanofiber sheet having opposing major surfaces, a layer of the second material on at least one of the opposing major surfaces of the fourth nanofiber sheet; a resilient connection between the third triboelectric element and the fourth triboelectric element, wherein the third triboelectric element and the fourth triboelectric element are configured so that the layer of the first material and the layer of the second material are configured to be brought into reversible contact with one another, and wherein the second triboelectric element and the third triboelectric element are configured to be brought into reversible contact with one another.

Example 16 includes the subject matter of Example 15, further comprising a frame connected to the triboelectric generator assembly.

Example 17 includes the subject matter of Example 16, wherein the frame includes: a top plate connected to the fourth triboelectric element; a bottom plate connected to the first triboelectric element; and at least one spring connected to the top and the bottom plates and providing a force urging the top plate and the bottom plate apart.

Example 18 includes the subject matter of any of Examples 15-17, wherein the first, second, third, and fourth triboelectric elements are in contact with adjacent triboelectric elements when the triboelectric generator assembly is in a compressed state.

Example 19 is a method for fabricating a triboelectric generator comprising: providing a first carbon nanofiber sheet and a second carbon nanofiber sheet; applying a first material to the first carbon nanofiber sheet, the first material having a positive triboelectric affinity; applying a second material to the second carbon nanofiber sheet, the second material having a negative triboelectric affinity; and connecting the first carbon nanofiber sheet and the second carbon nanofiber sheet together, the connecting configured for reversible contact between the first carbon nanofiber sheet and the second carbon nanofiber sheet.

Example 20 includes the subject matter of Example 19, further comprising infiltrating an electrically conductive material into at least one of the first carbon nanofiber sheet and the second carbon nanofiber sheet.

Example 21 is a method for using a triboelectric generator comprising: applying a compressive force to a triboelectric generator, the triboelectric generator comprising a first carbon nanofiber sheet coated with a first layer of a first material having a positive triboelectric affinity and a second carbon nanofiber sheet coated with a second layer of a second material having a negative triboelectric affinity; responsive to the applied compressive force, causing the first layer of the first carbon nanofiber sheet and the second layer of the second carbon nanofiber sheet to contact one another; and collecting electrical energy generated from the contact between the first layer and the second layer.

Example 22 includes the subject matter of any of Examples 1-18, wherein at least the first or second nanofiber sheet comprises carbon nanotubes.

Example 23 includes the subject matter of Example 22, wherein the carbon nanotubes comprise multi-walled carbon nanotubes.

Example 24 includes the subject matter of Example 22, wherein at least one of the nanofiber sheets is drawn from a carbon nanotube forest.

Example 25 includes the subject matter of any of Examples 1-18, wherein at least one of the nanofiber sheets is a carbon nanofiber sheet and another of the nanofiber sheets is not a carbon nanofiber sheet.

### BRIEF DESCRIPTION OF THE DRAWINGS

FIG. 1 illustrates a set of triboelectric elements that includes a first triboelectric element and a second triboelectric element, in an example of the present disclosure.

FIG. 2 illustrates a triboelectric assembly that includes three sets of triboelectric elements, in an example of the present disclosure.

FIGS. 3A-3E illustrate configurations of nanofiber sheet triboelectric elements associated during a folding process to produce a resilient structure for use as a triboelectric assembly, in an example of the present disclosure.

FIG. 3F is an example method for folding triboelectric elements into a resilient structure, as depicted in FIGS. 3A-3E, in an example of the present disclosure.

FIG. 4A illustrates a triboelectric generator assembly in an expanded state in the absence of a compressive force, in an example of the present disclosure.

FIG. 4B illustrates a triboelectric generator assembly in a compressed state in response to a compressive force, in an example of the present disclosure.

FIG. 5A is a schematic view of a triboelectric generator system in an expanded state that includes the triboelectric generator assembly depicted in FIG. 4A that is within a resilient frame, in an example of the present disclosure.

FIG. 5B is a schematic view of a triboelectric generator system in a compressed state that includes the triboelectric generator assembly depicted in FIG. 4B that is within a resilient frame, in an example of the present disclosure.

FIG. 6A is a method flow diagram illustrating an example method for the fabrication of a triboelectric generator assembly, in an example of the present disclosure.

FIG. 6B is a method flow diagram illustrating an example method of the use of a triboelectric generator assembly, in the example of the disclosure.

FIG. 7 illustrates an example forest of nanofibers on a substrate, in an example of the present disclosure.

FIG. 8 is a schematic view of a furnace for the growth and synthesis of a nanofiber forest, in an example of the present disclosure.

FIG. 9 is an illustration of a nanofiber sheet that identifies relative dimensions of the sheet and schematically illustrates nanofibers within the sheet aligned end-to-end in a plane parallel to a surface of the sheet, in an example of the present disclosure.

FIG. 10 is an image of a nanofiber sheet being laterally drawn from a nanofiber forest, the nanofibers aligning from end-to-end as schematically shown in FIG. 9, in an example of the present disclosure.

The figures depict various embodiments of the present disclosure for purposes of illustration only. Numerous variations, configurations, and other embodiments will be apparent from the following detailed discussion. Furthermore, as will be appreciated, the figures are not necessarily drawn to scale or intended to limit the described embodiments to the specific configurations shown. For instance, while some figures generally indicate straight lines, right angles, and smooth surfaces, an actual implementation of the disclosed techniques may have less than perfect straight lines and right angles, and some features may have surface topography or otherwise be non-smooth, given real-world limitations of fabrication processes. In short, the figures are provided merely to show example structures.

### DETAILED DESCRIPTION

### Overview

Examples of a triboelectric generator of the present disclosure include a set of two triboelectric elements. A first triboelectric element includes a first nanofiber sheet and a coating of a first material having a positive triboelectric affinity. A second triboelectric element includes a second nanofiber sheet and a coating of a second material having a negative triboelectric affinity. The first and second triboelectric elements are arranged into a set so that a surface of the first triboelectric element and a surface of the second triboelectric element (“confronting surfaces”) can contact and separate from one another repeatedly. This is optionally referred to as “reversible contact” herein. Because the first confronting surface of a nanofiber sheet is coated with (and/or infiltrated with) the first material having a positive triboelectric affinity and the second confronting surface of a nanofiber sheet is coated with (and/or infiltrated with) the second material having a negative triboelectric affinity, repeated contact and separation between the two triboelectric elements can transfer electrons and thus generate electrical energy. In some examples, a plurality of sets of first and second triboelectric elements can be arranged, thus increasing the amount of electrical energy produced per unit time due to the increased surface area between confronting elements. The set (or sets) can, in some examples, be placed in electrical communication with each other and/or with a common electrical load (e.g., an energy storage device, an electrically powered device).

### Components of a Set of Triboelectric Elements

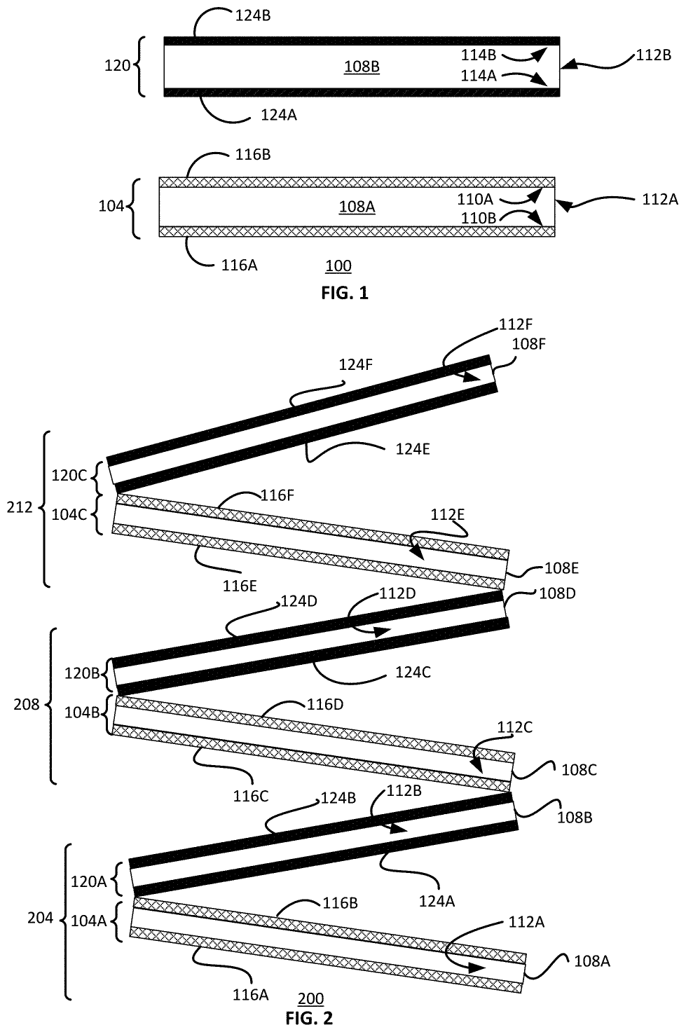

FIG. 1 illustrates a set 100 of triboelectric elements that includes a first triboelectric element 104 and a second triboelectric element 120. As described herein, the first triboelectric element 104 and the second triboelectric element 120 can be brought into contact with one another repeatedly so as to generate an electrical charge (or equivalently an electrical current when conducted away by one or more conductors connected to the set 100).

The first triboelectric element 104 includes a nanofiber sheet 108A having opposing major surfaces 110A, 110B. The first triboelectric element 104 is optionally infiltrated with an electrically conductive material 112A (generically 112). One or both of the opposing major surfaces 110A, 110B include a layer of a first material having a positive triboelectric affinity 116A, 116B (generically 116).

The triboelectric element 120 includes components analogous to those in the first triboelectric element 104. That is, the second triboelectric element 120 includes a nanofiber sheet 108B having opposing major surfaces 114A, 114B, an optionally infiltrated conductive material 112B, and layers of a second material having a negative triboelectric affinity 124A, 124B (generically 124) on one or both of the opposing major surfaces 114A, 114B.

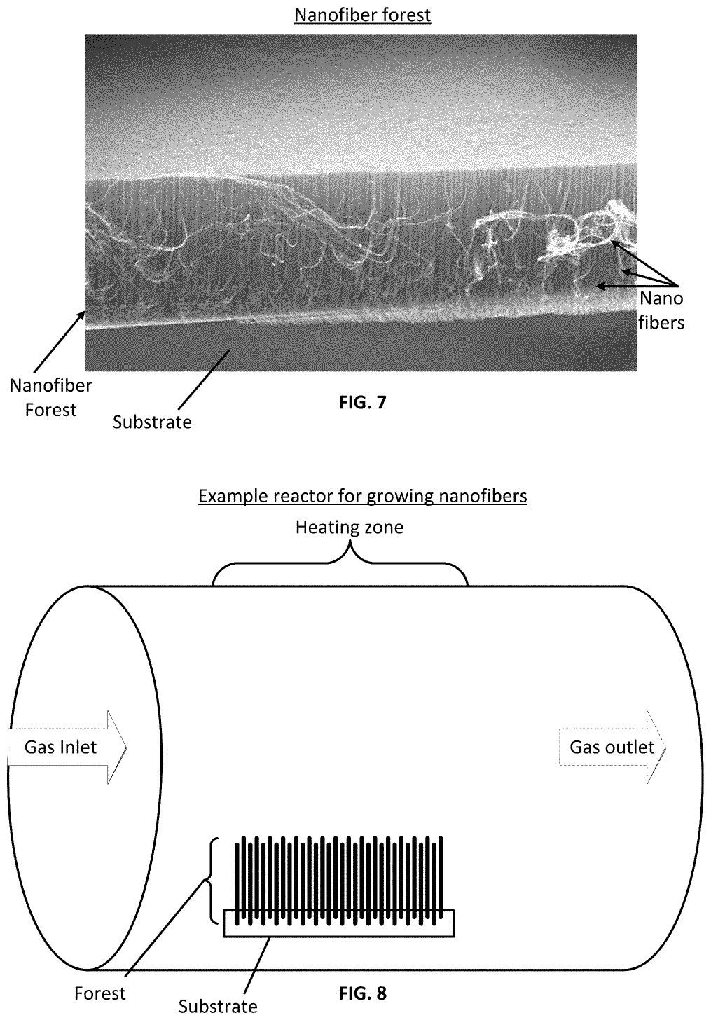

The nanofiber sheets 108A, 108B include a plurality of, for example, carbon nanofibers and/or carbon nanotubes having a longitudinal axis substantially aligned (i.e., +/−20°) with the corresponding opposing major surfaces 110A, 110B or 114A, 114B, respectively. It will be appreciated that the alignment of the carbon nanofibers and/or carbon nanotubes includes variation in the orientation of a corresponding longitudinal axis along each of the nanofibers/nanotubes. It will be further appreciated that some of the carbon nanofibers and/or carbon nanotubes can be entangled with one another. Additional details on the fabrication of carbon nanofibers/carbon nanotubes, and nanofiber sheets 108A, 108B (drawn from a nanofiber forest) appear below in the context of FIGS. 7-10.

Nanofiber sheets 108A, 108B have a thickness in a range of from 100 microns to 10 mm. Generally, a thickness of the nanofiber sheet 108A, 108B, and of the triboelectric elements 104, 120 can be selected so as to produce a high electrical conductivity to better conduct the electricity produced by actuation of a triboelectric generator, as described below. Another factor to consider when selecting a thickness of the nanofiber sheets 108A, 108B and/or triboelectric elements 104, 120 is the flexure of the sheets and/or triboelectric elements under their own weight. In one example, electricity generation per unit time will be improved when the triboelectric elements are separated from one another completely (other than at an electrically insulated resilient point, described below) prior to recontacting them. If the sheets and/or triboelectric elements bow under their own weight and/or flex so as to have a curvature that departs from the planar configuration shown in the figures, additional separation may be required. In some examples, thicker sheets can improve rigidity, minimizing bowing and the separation required, thus decreasing the time required to complete one cycle of actuation and improving the quantity of energy produced per unit time.

The optional electrically conductive material 112A and 112B (generically 112) can be infiltrated into one or both of the nanofiber sheets 108A 108B. That is, the electrically conductive material 112A, 112B can be applied to the nanofiber sheets 108A, 108B so as to pass through the one or more of the corresponding major surfaces 110, 114 of the sheet(s) 108A, 108B, ultimately to be disposed within gaps defined by and between individual nanofibers of the sheets 108A, 108B. In some examples, the electrically conductive material 112 can be a conductive polymer that is optionally infiltrated into the nanofiber sheets 108A, 108B using a solvent that later is removed (e.g., by evaporation). The electrically conductive material 112 can be applied to and/or infiltrated within the nanofiber sheets 108A, 108B so as to improve electrical contact between a triboelectric material (e.g., 116, 124) and a corresponding nanofiber sheet, thus improving the generation, collection, and/or transmission of electrical energy during actuation of the set 100 of triboelectric elements. In some examples, the electrically conductive material 112 can improve electrical contact between nanofibers within the nanofiber sheet 108, thus improving conductivity of the nanofiber sheet 108 as a whole. A material is considered electrically conductive if it has an electrical conductivity within an order of magnitude (+/−30%) to that of a metallic conductor. Example values appear below in Table 1. From these values, it can be seen that a multilayered carbon nanotube sheet coated with PEDOT:PSS and treated with acid (as described herein), can produce sheet resistance values that can be considered electrically conductive by comparison to the sheet resistance of commercially available aluminum foil.

| Material | Sheet Resistance (Ohm/sq) |
|---|---|
| Aluminum foil | 0.066 |
| Collapsed carbon nanotube forest | 4.9 |
| Carbon nanotube sheet/PEDOT:PSS | 4.45 |
| (sprayed and acid treated) | |
| Carbon nanotube sheet/PEDOT:PSS | 0.97 |
| (multilayered and acid treated) | |

In one example, a polymer that can be used for the electrically conductive material 112 is poly(3,4-ethylenedioxythiophene) polystyrene sulfonate, also known as “PEDOT:PSS.” Alternative example conductive polymers include, but are not limited to, polypyrrole and polyaniline. In still other examples, the electrically conductive material 112 can include electrically conductive micro and/or nanoparticles (e.g., silver, gold, copper, aluminum, graphene) that are infiltrated into interfiber gaps defined by and between the nanofibers of the nanofiber sheet.

Conductive materials can be introduced to the interfiber gaps using any technique capable of delivering the electrically conductive material into the nanofiber sheet. For instance, the electrically conductive material can infiltrate the sheet as a liquid or can be deposited via vapor deposition. Infiltration of the electrically conductive material 112 (whether metallic or polymeric or both) can be accomplished by suspending or dissolving the conductive material in a volatile solvent. The solution or suspension (or both) is then applied to the nanofiber sheet. The solvent and the dissolved conductive polymer and/or suspended conductive particles flow into the nanofiber sheet, and more specifically, into the interfiber gaps defined by and between the nanofibers of the nanofiber sheet. The volatile solvent is then removed (e.g., by heating, evaporation, vacuum, combinations thereof), leaving the polymer and/or particles within an interior of the nanofiber sheet 108, including within the interfiber gaps. In various embodiments, the electrically conductive material can fill greater than 1%, greater than 5%, greater than 10%, greater than 20% or greater than 50% of the voids between the nanofibers. In the same and other embodiments, the electrically conductive material can fill less than 90%, less than 50%, less than 20% or less than 10% of the voids between the nanofibers.

In examples in which PEDOT:PSS is used as the electrically conductive material 112, the PEDOT:PSS can be treated with an enhancing agent (such as sulfuric acid) that improves the electrical conductivity of the PEDOT:PSS, and thus the electrical conductivity of the triboelectric generator as a whole (as will be described below in more detail). For example, once infiltrated into a nanofiber sheet, the PEDOT:PSS can be soaked in sulfuric acid at a temperature in a range of from 120° C. to 170° C. for from 10 minutes to one hour. This additional processing has been recognized as improving electrical conductivity of PEDOT:PSS. In other examples, the enhancing agent can include ethylene glycol, dimethyl sulfoxide, among others, which can be applied to PEDOT:PSS infiltrated nanofiber sheet 108 and heated using temperatures and times analogous to those used for sulfuric acid.

The first 116 and second 124 materials having opposite triboelectric affinity polarities can be formed, in examples, from materials selected from the non-limiting triboelectric series presented in Table 2. The greater the difference between oppositely signed values, the greater the charge generated when the two corresponding materials are placed in contact with one another. For example, a triboelectric device made by contacting polyurethane and Teflon will produce more electrical energy per cycle than a device made by contacting nitrile rubber with polycarbonate.

TABLE 2

| | Triboelectric |
|---|---|
| Material | Affinity (nC/J) |
| Polyurethane foam | +60 |
| Solid polyurethane, filled | +40 |
| Nylon | +30 |
| Nylatron (nylon filled with | +28 |
| MoS₂) | |
| Glass (soda) | +25 |
| Paper (uncoated copy) | +10 |
| GE brand Silicone II | +6 |
| Nitrile rubber | +3 |
| Polycarbonate | −5 |
| ABS | −5 |
| polymethyl methacrylate | −10 |
| Epoxy (circuit board) | −32 |
| Styrene-butadiene rubber | −35 |
| Solvent-based spray paints | −38 |
| PET | −40 |
| EVA rubber for gaskets, filled | −55 |
| Gum rubber | −60 |
| Hot melt glue | −62 |
| Polystyrene | −70 |
| Polyimide | −70 |
| Silicones (air harden | −72 |
| & thermoset, but not GE) | |
| Olefins (alkenes): LDPE, | −90 |
| HDPE, PP | |
| nitrate | −93 |
| UHMWPE | −95 |
| PVC (rigid vinyl) | −100 |
| Latex (natural) rubber | −105 |
| Viton, filled | −117 |
| Epichlorohydrin rubber, filled | −118 |
| Hypalon rubber, filled | −130 |
| Butyl rubber, filled | −135 |
| EDPM rubber, filled | −140 |
| Teflon | −190 |
| (polytetrafluoroethylene) | |

However, even if contacting polyurethane and Teflon produces a strong electrical charge, it is challenging to collect and use the charge as an electrical current because both polyurethane and Teflon are electrical insulators. In some examples of the present disclosure, this challenge is overcome by using a conductive nanofiber sheet to conduct the generated electricity. In some examples, coating the nanofiber sheet with a conductive coating (e.g., PEDOT:PSS) can further improve electrical contact between triboelectric material and the nanofiber sheet. As a result, in various embodiments the difference in triboelectric affinity (nC/J) between confronting sheets can be greater than 50, greater than 75, greater than 100, greater than 125, greater than 150, greater than 175, greater than 200 or greater than 225 nC/J.

As can be appreciated in light of the present disclosure, an amount of energy generated per instance of contact between triboelectric elements having coatings of opposite polarities of triboelectric materials is only one factor that affects the quantity of electrical energy that is generated. It will be further appreciated that an amount of electrical energy generated is also proportional to a surface area of contact between triboelectric elements in a set, the number of sets of triboelectric elements that are cycling into and out of contact, and the frequency of contact between confronting surface per unit time.

### Triboelectric Generator Assemblies

While a single set of confronting surfaces described above can be used to generate electrical energy, there are additionally convenient techniques in which multiple sets of triboelectric elements can be assembled so as to increase an amount of electrical energy generated per cycle of actuation (i.e., contact between and subsequent separation of confronting surfaces of first and second triboelectric elements) of a triboelectric element. One such example is illustrated in FIG. 2.

The assembly 200 in FIG. 2 includes three sets of triboelectric elements 204, 208, and 212. Each set of triboelectric elements includes an analog to triboelectric element 104 and triboelectric element 120. Specifically, each set of the triboelectric elements 204, 208, and 212 includes a nanofiber sheet 108A-108F, an electrically conductive material 112A-112F, a material having a positive triboelectric affinity 116A-116F, and a material having a negative triboelectric affinity 124A-124F. These individual elements have been described above and need no further explanation.

As is apparent upon inspection, the assembly 200 has increased surface area between confronting surfaces with materials having opposite triboelectric affinity compared to the set 100 for at least two reasons. First, the assembly 200 includes three sets 204, 208, 212 of triboelectric elements, which increases the confronting surface area of the assembly 200 by a factor of 3 relative to the set 100 depicted in FIG. 1. Second, for a structure such as the one illustrated in FIG. 2, additional surfaces of contact are present between first and second triboelectric elements of adjacent sets. In this example 200, the second triboelectric element 120A of the set 204 confronts and is configured to contact the first triboelectric element 104B of the set 208. Similarly, the second triboelectric element 120B of the set 208 confronts and is configured to contact the first triboelectric element 104C of the set 212. With these additional surfaces in contact, a total increase in confronting surface area of the assembly 200 increases by a factor of 5 relative to the set 100 depicted in FIG. 1.

In some examples, a total area of interfaces between confronting faces of triboelectric elements with opposite triboelectric affinities can be 1 meters² (m²) per 0.00625 m³. The proportionate relationship between interfacial area and cubic volume of an assembly of triboelectric elements can in some examples remain approximately (+/−15%) constant as the interfacial area and volume increase with the addition of additional triboelectric elements. In other examples, this relationship can be from 1 m² to 5 m² per volume of 0.005 m³ to 0.1 m³. A minimum displacement to separate adjacent triboelectric elements from one another can, in some examples, be determined (assuming that the elements do not flex or sag during separation) as a function of the number of elements to be separated and the size of the sheets. For example, if one centimeter separation is needed to fully separate two elements of a single set from one another (calculated based on the size of the sheet and the angle between the sheets needed for separation), and the assembly includes three connected sets, a total displacement of 5 centimeters of the three connected sets would be sufficient for actuation of the system as a whole.

Devices such as the assembly 200, and analogous devices, can be constructed in any number of ways. In one example, the sets 204, 208, and 212 can be fabricated from two separate nanofiber sheets that are folded together to form a resilient structure that reversibly compresses in response to an applied compressive force and spontaneously returns to its un-compressed state, spring-like, when the applied compressive force is removed.

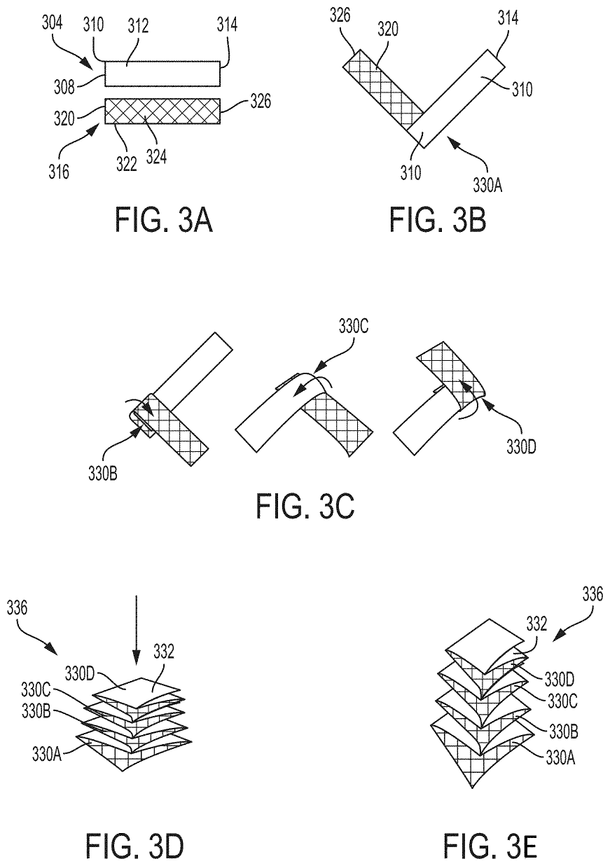

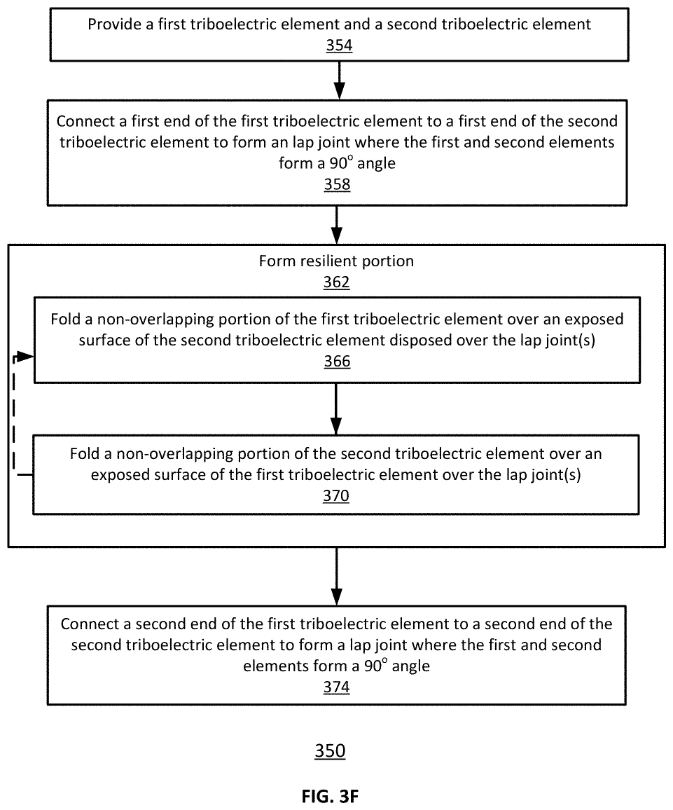

FIGS. 3A-3E illustrate a method by which the nanofiber sheets (both infiltrated an the electrically conductive material, one coated with the material having the positive triboelectric affinity, and one coated with the material having the negative triboelectric affinity) are folded together. A schematic representation of a folding process is shown in FIGS. 3A-3E. A corresponding method 350 for folding triboelectric elements made from nanofiber sheets into a resilient structure is shown in FIG. 3F.

As shown, a first triboelectric element 304 (analogous to the first triboelectric elements described above) includes a nanofiber sheet 308 and a layer of a first triboelectric material 312 disposed on opposing major surfaces of the nanofiber sheet 308. A second triboelectric element 316 (analogous to the second triboelectric elements described above) includes a nanofiber sheet 320 and a layer of a second triboelectric material 324 disposed on opposing major surfaces of the nanofiber sheet 320. The first triboelectric material 312 and the second triboelectric material 316 are analogous to those described above and need no further explanation.

The example method 350 begins by providing 354 the first and second triboelectric elements 304, 316. As shown in FIG. 3B, a first end 310 of the first triboelectric element 304 is connected 358 to a first end 322 of the second triboelectric element 316. These ends 310, 322 are connected 358 in a lap joint 330A so as to form an approximate 90° angle (+/−5°). The lap joint 330A can be formed using a fixed connection that can include, but is not limited to, an adhesive, a mechanical fixture (e.g., a clamp or staple), or some other similar technique. As shown in a first image of FIG. 3C, a non-overlapping portion of the first triboelectric element 308 is folded 366 over an exposed surface of the second triboelectric element 320, again forming a lap joint (330B). However, the lap joint depicted in FIG. 3C does not include a fixed connection. As shown in a second image of FIG. 3C, a nonoverlapping portion of the second triboelectric element is then folded 370 over an exposed surface of the first triboelectric element over the lap joints to form yet another lap joint 330C. This may be optionally repeated number of times, as shown in the third image of FIG. 3C as lap joint 330D. A final lap joint 332 is formed by fixedly connecting 374 the second ends 314, 326 of the first triboelectric element 308 and the second triboelectric element 320, respectively. Similar to the first lap joint 330A, the two triboelectric elements form an approximate 90° angle (+/−5°) when fixedly connected in the final lap joint 332.

The resilient assembly 336 formed by this folding method 350 can be compressed as shown in FIG. 3D in response to an applied compressive force. However, the release of this compressive force, the resilient element 336 expands as shown in FIG. 3E. In this way, the resilient assembly 336 can be used to generate electrical energy similar to structures described in alternative examples herein.

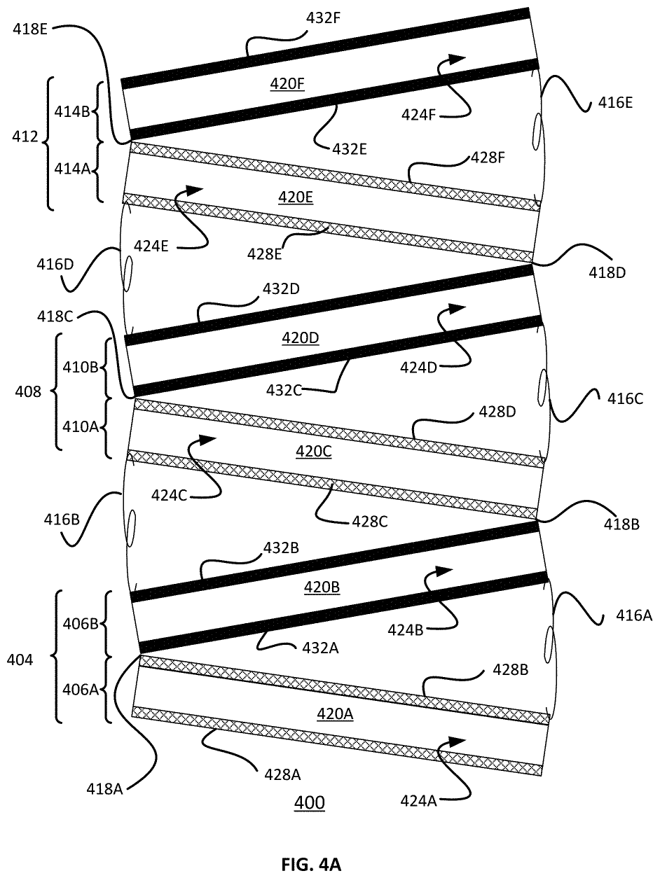

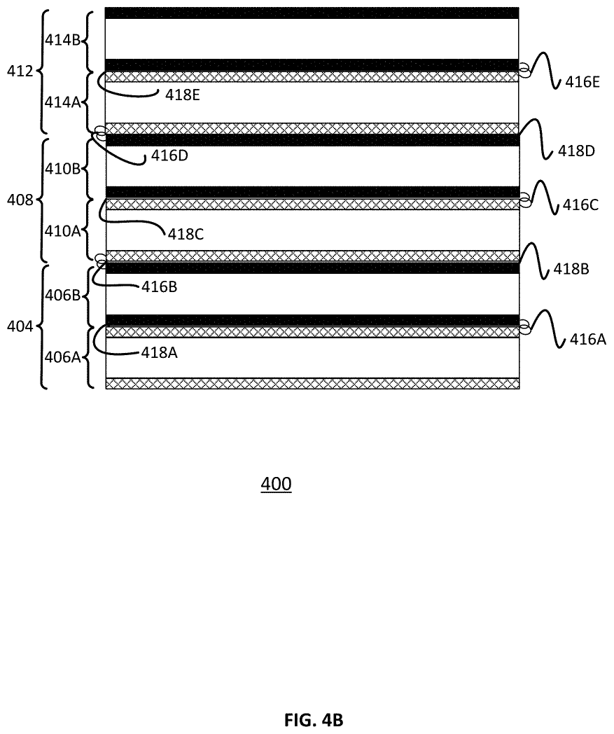

In another example, illustrated in FIG. 4A, triboelectric elements within a triboelectric generator assembly 400 (the elements of which are analogous to those of the assembly 200 described above) are connected to one another via springs and pivot structures. The springs facilitate the resilient and repeatable compression and expansion that facilitates repeated contact between confronting surfaces coated with materials having opposite triboelectric affinities, as described above. Pivot structures can also facilitate repeated contact between the triboelectric elements and also facilitate proper alignment between the elements when contacting one another. This has the benefit of maximizing the surface area between adjacent elements that are in contact during compression, thus maximizing the amount of electrical energy generated per cycle. Furthermore, the use of springs and/or pivot structures can increase the number of cycles (i.e., one compression and one expansion) performed by the triboelectric generator assembly 400 per unit time because of the added mechanical stability provided by the springs and/or pivot structures.

The triboelectric generator assembly 400 shown in FIG. 4A in an expanded state includes triboelectric element sets 404, 408, and 412 and springs 416A-416E (generically 416). It will be appreciated that conductive elements that establish an electrical connection between the triboelectric generator assembly 400 and an electrical energy storage device or load can be present but are omitted for clarity.

The triboelectric element sets 404, 408, and 412 are analogous to those described above in the context of FIG. 2. That is, the triboelectric element set 404 includes triboelectric elements 406A, 406B, triboelectric element set 408 includes triboelectric elements 410A, 410B, and triboelectric element set 412 include a triboelectric elements 414A, 414B. Each of the triboelectric elements 406A, 406B, 410A, 410B, 414A, 414B includes a nanofiber sheet 420A-420F, an optional electrically conductive material 424A-424F that is infiltrated and/or disposed within the interfiber gaps of corresponding nanofiber sheets 420A-420F, and one of a material having a positive triboelectric affinity 428A-428F or and a material having a negative triboelectric affinity 432A-432F. Because the individual components of the triboelectric elements 406A, 406B, 410A, 410B, 414A, 414B are analogous to those described in FIG. 2, they need no further explanation.

The springs 416 connect adjacent triboelectric elements to each other, whether the elements are associated with a same set or with two different sets. For example, as shown in FIG. 4A, compression spring 416A connects triboelectric elements 406A and 406B within the set 404, and urges them apart in the absence of a compressive force. The spring 416B connects triboelectric elements 406B and 410A of sets 404 and 408 respectively, and urges them apart in the absence of a compressive force. The spring 416C connects triboelectric elements 410A and 410B within the set 408, and urges them apart in the absence of a compressive force. The spring 416D connects triboelectric elements 410B and 414A of the sets 408 and 412 respectively, and urges them apart in the absence of a compressive force. The spring 416E connects triboelectric elements 414A and 414B within the set 412, and urges them apart in the absence of a compressive force.

The example illustrated in FIG. 4A also includes pivot structures 418A-418E (generically or collectively, 418). These pivot structures 418 are, in this example, on a side of the triboelectric element sets 404, 408, 412 opposite that of the springs 416A-416E. The pivot structures 418A-418E help maintain contact between the various adjacent triboelectric elements 406, 410, 414 during compression and expansion of the assembly 400. Maintaining contact in this way can also facilitate maintaining alignment between the various adjacent triboelectric elements 406, 410, 414 during compression and expansion, which in turn maintains an efficiency of electrical power generation. In other words, because the pivot structures 418 maintain alignment between the various adjacent triboelectric elements 406, 410, 414, a maximum amount of surface area of the elements contacting one another is maintained throughout repeated cycles of actuation of the assembly 400. Because electrical energy is generated upon contact between elements having coatings with opposite triboelectric affinities, the amount of electrical energy generated per cycle of the assembly 400 is proportional to the contact surface area.

In some examples, the pivot structures 418A-418E can be hinges connected to adjacent triboelectric elements (e.g., 406A and 406B, 460B and 410A, 410A and 410B, 410B and 414A, 414A and 414B).

In some examples, the pivot structures 418A-418E are folds within one or more nanofiber sheets folded into a shape such as is illustrated in FIG. 4A. In another example, the pivot structures 418A-418E comprise two or more nanofiber sheets folded together so as to form a resilient structure like that is shown and described above.

Where FIG. 4A illustrates an example generator assembly 400 in an expanded state, FIG. 4B illustrates the example generator assembly 400 in compressed state. As shown, the materials having opposite triboelectric affinities (as indicated by shading consistent with the corresponding elements in FIG. 4A) are in contact with one another. Also as shown, the springs 416 are compressed, thus providing the resilient force that will urge adjacent triboelectric elements apart when the compressive force has been released. This will return the assembly 400 to the configuration illustrated in FIG. 4A until a compressive force is applied to the triboelectric generator 400, returning it to the state illustrated in FIG. 4B.

With this configuration, alternatively applying and releasing compressive force (corresponding to the states shown in FIGS. 4A, 4B) generates electrical energy as described above.

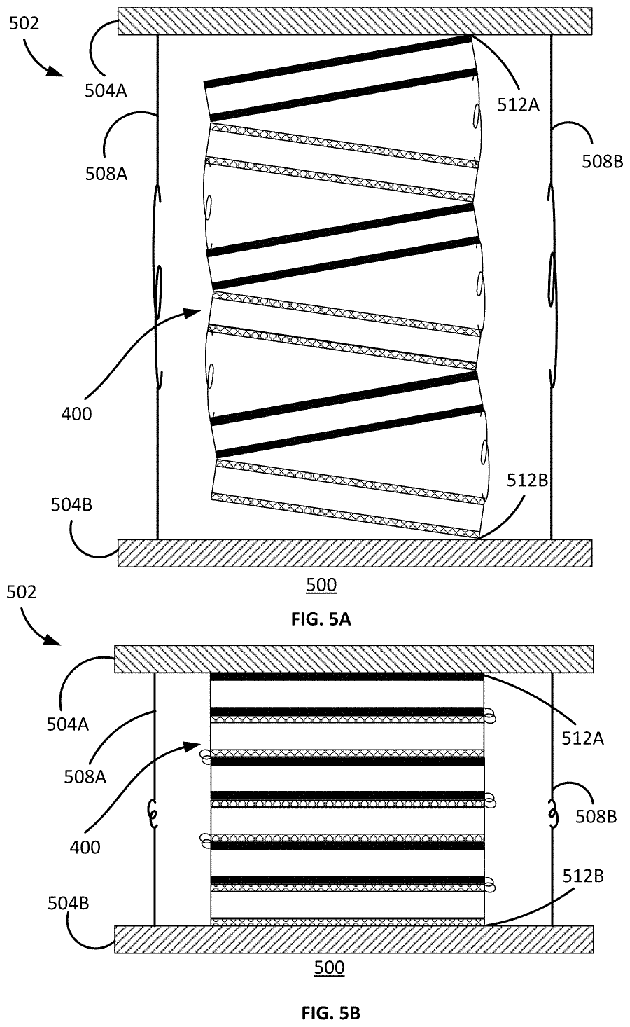

FIG. 5A is an example of a triboelectric generator system 500. The generator system 500 includes the assembly 400 described above that is secured inside a frame 502. It will be noted that the various components of the assembly 400 have not be labeled in FIG. 5A for clarity of illustration. But it will be appreciated that the operation of the assembly 400 within the system 500 is analogous to that shown in FIGS. 4A, 4B and described above.

The frame 502 of the generator system 500 facilitates the resilient and repeatable compression and expansion of the assembly 400, which in turn facilitates repeated contact between confronting surfaces of triboelectric elements that are coated with materials having opposite triboelectric affinities, as described above. Use of the generator system 500 with the frame 502 can further increase the number of cycles (i.e. one compression and one expansion) performed by the triboelectric generator system 500 per unit time because of the added mechanical stability and resilience (i.e., and ability to return to an uncompressed state upon release of a compressive force) provided by the frame 502.

The frame 502 includes a top plate 504A, a bottom plate 504B, and two springs 508A and 508B. The springs 508A, 508B are connected to the top and the bottom plates 504A, 504B, urging them apart in the absence of a compressive force. The example illustrated in FIG. 5A also includes pivot structures 512A and 512B (generically and collectively, 512). The pivot structure 512A helps maintain contact and alignment between the top plate 504A of the frame 502 and an adjacent triboelectric element. The pivot structure 512B helps maintain contact and alignment between the bottom plate 504B of the frame 502 and an adjacent triboelectric element. Maintaining contact in this way can also facilitate maintaining alignment between the various adjacent triboelectric elements (as mentioned above) during compression and expansion of the generator system 500, which in turn maintains an efficiency of electrical power generation. The additional mechanical support provided by the frame 502 to the triboelectric generator assembly 400 can increase a number of compression and expansion cycles per unit time, that in turn can increase an amount of electrical energy generated per cycle of the assembly (as explained above).

FIG. 5B illustrates the example generator system 500 in compressed state. As shown, the triboelectric elements having coatings/layers with opposite triboelectric affinities (as explained above and shown in FIG. 4B) are in contact with one another. Also as shown, the springs 508A and 508B of the frame 502 and of the assembly 400 are compressed, thus providing a resilient force that will urge the top plate 504A and the bottom plate 504B apart (along with any directly or indirectly connected triboelectric elements) upon release of the compressive force. This will return the generator system 500 to the configuration illustrated in FIG. 5A until another compressive force is applied to the triboelectric generator system 500, returning it to the state illustrated in FIG. 5B. A first material having a positive triboelectric affinity is applied 616 to a first nanofiber sheet. Similarly, a second material having a negative triboelectric affinity is applied 620 to a second nanofiber sheet.

### Method

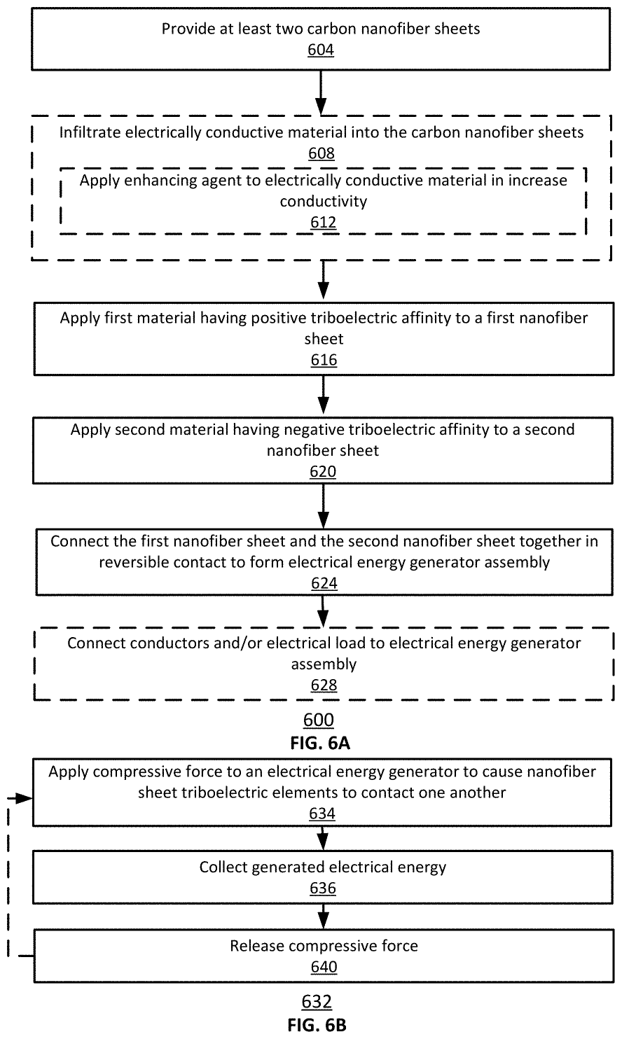

FIG. 6A illustrates an example method 600 for fabricating a triboelectric assembly for use as an electrical energy generator, in an example of the present disclosure. The method 600 begins by providing 604 at least two carbon nanofiber sheets. The nanofiber sheets may be optionally infiltrated 608 with an electrically conductive material, examples of which have been described above. For examples in which an electrically conductive material has been infiltrated 608 into one or more of the carbon nanofiber sheets, an enhancing agent may be optionally applied 612 to the electrically conductive material to increase the electrical conductivity. Again, examples of this have been described above and need no further explanation.

The method 600 continues by applying 616 a first material having a positive triboelectric affinity to a first nanofiber sheet. Similarly, the method 600 includes applying 620 a second material having a negative triboelectric affinity to a second nanofiber sheet. The first material and the second material can, in some examples, be selected from the triboelectric series depicted above in Table 2. The first nanofiber sheet and the second nanofiber sheet are then connected 624 to be in reversible contact with one another, thus forming an electrical energy generator assembly. The connections can include pivot structures, springs, frames, and other analogous structures to facilitate contact in response to an applied compressive force and disconnection of the contact (i.e., resilience) in absence of the compressive force. In this way electrical energy can be generated through repeated contact between confronting surfaces of the first and second nanofiber sheets on which are disposed layers that have opposite polarities of triboelectric affinity. In some cases, conductors and/or electrical load may be connected 628 to the electrical energy generator assembly so as to apply the electrical energy generated to some practical purpose.

FIG. 6B illustrates a method 632 for using the electrical energy generator assembly fabricated according to the example method 600. The method 632 begins by applying 634 a compressive force to an electrical energy generator, configured as described herein. The compressive force that is applied 634 causes the nanofiber sheet triboelectric elements, also described above, to contact one another. The triboelectric elements that contact one another and that have coatings or layers disposed thereon with opposite polarity triboelectric affinities generate electricity in response to the contact. This generated electrical energy can be collected 636. The compressive force may then be released 640. The method 632 me than optionally be repeated to produce more electrical energy.

### Nanofiber Forests

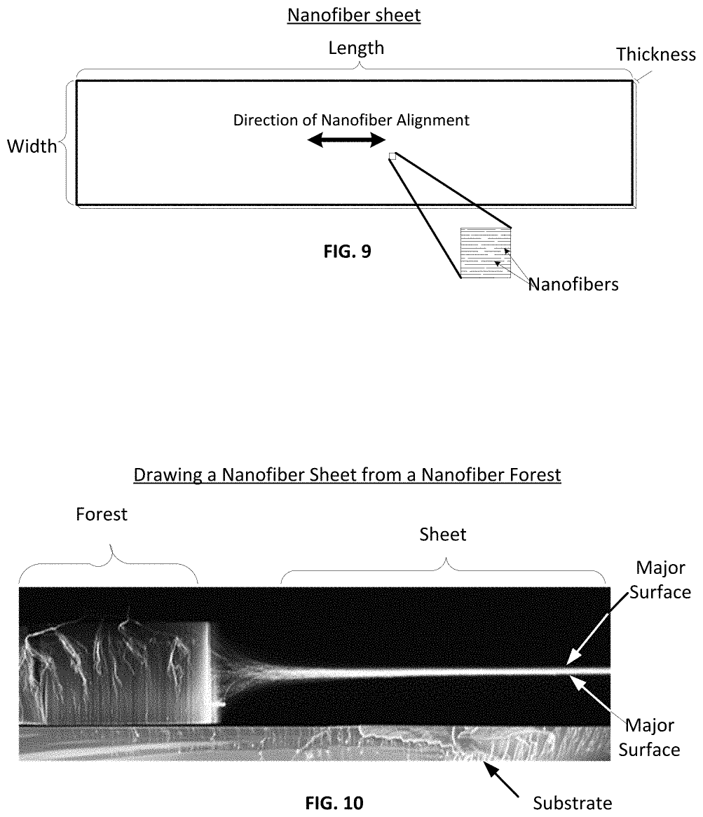

As used herein, the term “nanofiber” means a fiber having a diameter less than 1 μm. While the embodiments herein are primarily described as fabricated from carbon nanotubes, it will be appreciated that other carbon allotropes, whether graphene, micron or nano-scale graphite fibers and/or plates, and even other compositions of nano-scale fibers such as boron nitride may be densified using the techniques described below. As used herein, the terms “nanofiber” and “carbon nanotube” encompass both single walled carbon nanotubes and/or multi-walled carbon nanotubes in which carbon atoms are linked together to form a cylindrical structure. In some embodiments, carbon nanotubes as referenced herein have between 4 and 10 walls. As used herein, a “nanofiber sheet” or simply “sheet” refers to a sheet of nanofibers aligned via a drawing process (as described in PCT Publication No. WO 2007/015710, and incorporated by reference herein in its entirety) so that a longitudinal axis of a nanofiber of the sheet is parallel to a major surface of the sheet, rather than perpendicular to the major surface of the sheet (i.e., in the as-deposited form of the sheet, often referred to as a “forest”). This is illustrated and shown in FIGS. 8 and 9, respectively.

The dimensions of carbon nanotubes can vary greatly depending on production methods used. For example, the diameter of a carbon nanotube may be from 0.4 nm to 100 nm and its length may range from 10 μm to greater than 55.5 cm. Carbon nanotubes are also capable of having very high aspect ratios (ratio of length to diameter) with some as high as 132,000,000:1 or more. Given the wide range of dimensional possibilities, the properties of carbon nanotubes are highly adjustable, or “tunable.” While many intriguing properties of carbon nanotubes have been identified, harnessing the properties of carbon nanotubes in practical applications requires scalable and controllable production methods that allow the features of the carbon nanotubes to be maintained or enhanced.

Due to their unique structure, carbon nanotubes possess particular mechanical, electrical, chemical, thermal and optical properties that make them well-suited for certain applications. In particular, carbon nanotubes exhibit superior electrical conductivity, high mechanical strength, good thermal stability and are also hydrophobic. In addition to these properties, carbon nanotubes may also exhibit useful optical properties. For example, carbon nanotubes may be used in light-emitting diodes (LEDs) and photo-detectors to emit or detect light at narrowly selected wavelengths. Carbon nanotubes may also prove useful for photon transport and/or phonon transport.

In accordance with various embodiments of the subject disclosure, nanofibers (including but not limited to carbon nanotubes) can be arranged in various configurations, including in a configuration referred to herein as a “forest.” As used herein, a “forest” of nanofibers or carbon nanotubes refers to an array of nanofibers having approximately equivalent dimensions that are arranged substantially parallel to one another on a substrate. FIG. 7 shows an example forest of nanofibers on a substrate. The substrate may be any shape but in some embodiments the substrate has a planar surface on which the forest is assembled. As can be seen in FIG. 7, the nanofibers in the forest may be approximately equal in height and/or diameter.

Nanofiber forests as disclosed herein may be relatively dense. Specifically, the disclosed nanofiber forests may have a density of at least 1 billion nanofibers/cm2. In some specific embodiments, a nanofiber forest as described herein may have a density of between 10 billion/cm2 and 30 billion/cm2. In other examples, the nanofiber forest as described herein may have a density in the range of 90 billion nanofibers/cm2. The forest may include areas of high density or low density and specific areas may be void of nanofibers. The nanofibers within a forest may also exhibit inter-fiber connectivity. For example, neighboring nanofibers within a nanofiber forest may be attracted to one another by van der Waals forces. Regardless, a density of nanofibers within a forest can be increased by applying techniques described herein.

Methods of fabricating a nanofiber forest are described in, for example, PCT No. WO2007/015710, which is incorporated herein by reference in its entirety.

Various methods can be used to produce nanofiber precursor forests. For example, in some embodiments nanofibers may be grown in a high-temperature furnace, schematically illustrated in FIG. 8. In some embodiments, catalyst may be deposited on a substrate, placed in a reactor and then may be exposed to a fuel compound that is supplied to the reactor. Substrates can withstand temperatures of greater than 800° C. or even 1000° C. and may be inert materials. The substrate may comprise stainless steel or aluminum disposed on an underlying silicon (Si) wafer, although other ceramic substrates may be used in place of the Si wafer (e.g., alumina, zirconia, SiO2, glass ceramics). In examples where the nanofibers of the precursor forest are carbon nanotubes, carbon-based compounds, such as acetylene may be used as fuel compounds. After being introduced to the reactor, the fuel compound(s) may then begin to accumulate on the catalyst and may assemble by growing upward from the substrate to form a forest of nanofibers. The reactor also may include a gas inlet where fuel compound(s) and carrier gasses may be supplied to the reactor and a gas outlet where expended fuel compounds and carrier gases may be released from the reactor. Examples of carrier gases include hydrogen, argon, and helium. These gases, in particular hydrogen, may also be introduced to the reactor to facilitate growth of the nanofiber forest. Additionally, dopants to be incorporated in the nanofibers may be added to the gas stream.

In a process used to fabricate a multilayered nanofiber forest, one nanofiber forest is formed on a substrate followed by the growth of a second nanofiber forest in contact with the first nanofiber forest. Multi-layered nanofiber forests can be formed by numerous suitable methods, such as by forming a first nanofiber forest on the substrate, depositing catalyst on the first nanofiber forest and then introducing additional fuel compound to the reactor to encourage growth of a second nanofiber forest from the catalyst positioned on the first nanofiber forest. Depending on the growth methodology applied, the type of catalyst, and the location of the catalyst, the second nanofiber layer may either grow on top of the first nanofiber layer or, after refreshing the catalyst, for example with hydrogen gas, grow directly on the substrate thus growing under the first nanofiber layer. Regardless, the second nanofiber forest can be aligned approximately end-to-end with the nanofibers of the first nanofiber forest although there is a readily detectable interface between the first and second forest. Multi-layered nanofiber forests may include any number of forests. For example, a multi-layered precursor forest may include two, three, four, five or more forests.

### Nanofiber Sheets

In addition to arrangement in a forest configuration, the nanofibers of the subject application may also be arranged in a sheet configuration. As used herein, the term “nanofiber sheet,” “nanotube sheet,” or simply “sheet” refers to an arrangement of nanofibers where the nanofibers are aligned end to end in a plane. An illustration of an example nanofiber sheet is shown in FIG. 9 with labels of the dimensions. In some embodiments, the sheet has a length and/or width that is more than 100 times greater than the thickness of the sheet. In some embodiments, the length, width or both, are more than 10³, 10⁶ or 10⁹ times greater than the average thickness of the sheet. A nanofiber sheet can have a thickness of, for example, between approximately 5 nm and 30 μm and any length and width that are suitable for the intended application. In some embodiments, a nanofiber sheet may have a length of between 1 cm and 10 meters and a width between 1 cm and 1 meter. These lengths are provided merely for illustration. The length and width of a nanofiber sheet are constrained by the configuration of the manufacturing equipment and not by the physical or chemical properties of any of the nanotubes, forest, or nanofiber sheet. For example, continuous processes can produce sheets of any length. These sheets can be wound onto a roll as they are produced.

As can be seen in FIG. 9, the axis in which the nanofibers are aligned end-to end is referred to as the direction of nanofiber alignment. In some embodiments, the direction of nanofiber alignment may be continuous throughout an entire nanofiber sheet. Nanofibers are not necessarily perfectly parallel to each other and it is understood that the direction of nanofiber alignment is an average or general measure of the direction of alignment of the nanofibers.

Nanofiber sheets may be assembled using any type of suitable process capable of producing the sheet. In some example embodiments, nanofiber sheets may be drawn from a nanofiber forest. An example of a nanofiber sheet being drawn from a nanofiber forest is shown in FIG. 10.

As can be seen in FIG. 10, the nanofibers may be drawn laterally from the forest and then align end-to-end to form a nanofiber sheet. In embodiments where a nanofiber sheet is drawn from a nanofiber forest, the dimensions of the forest may be controlled to form a nanofiber sheet having particular dimensions. For example, the width of the nanofiber sheet may be approximately equal to the width of the nanofiber forest from which the sheet was drawn. Additionally, the length of the sheet can be controlled, for example, by concluding the draw process when the desired sheet length has been achieved.

Nanofiber sheets have many properties that can be exploited for various applications. For example, nanofiber sheets may have tunable opacity, high mechanical strength and flexibility, thermal and electrical conductivity, and may also exhibit hydrophobicity. Given the high degree of alignment of the nanofibers within a sheet, a nanofiber sheet may be extremely thin. In some examples, a nanofiber sheet is on the order of approximately 10 nm thick (as measured within normal measurement tolerances), rendering it nearly two-dimensional. In other examples, the thickness of a nanofiber sheet can be as high as 200 nm or 300 nm. As such, nanofiber sheets may add minimal additional thickness to a component.

As with nanofiber forests, the nanofibers in a nanofibers sheet may be functionalized by a treatment agent by adding chemical groups or elements to a surface of the nanofibers of the sheet and that provide a different chemical activity than the nanofibers alone. Functionalization of a nanofiber sheet can be performed on previously functionalized nanofibers or can be performed on previously unfunctionalized nanofibers. Functionalization can be performed using any of the techniques described herein including, but not limited to CVD, and various doping techniques.

Nanofiber sheets, as drawn from a nanofiber forest, may also have high purity, wherein more than 90%, more than 95% or more than 99% of the weight percent of the nanofiber sheet is attributable to nanofibers, in some instances. Similarly, the nanofiber sheet may comprise more than 90%, more than 95%, more than 99% or more than 99.9% by weight of carbon.

### Further Considerations

The foregoing description of the examples of the disclosure has been presented for the purpose of illustration; it is not intended to be exhaustive or to limit the claims to the precise forms disclosed. Persons skilled in the relevant art can appreciate that many modifications and variations are possible in light of the above disclosure.

The language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based hereon. Accordingly, the disclosure of the examples is intended to be illustrative, but not limiting, of the scope of the invention, which is set forth in the following claims.

What is claimed is:

1. A set of triboelectric elements comprising:
a first triboelectric element that includes:
a first nanofiber sheet having opposing major surfaces;
a layer of a first material on at least one of the opposing major surfaces of the first nanofiber sheet, the first material having a positive triboelectric affinity;
a second triboelectric element that includes:
a second nanofiber sheet having opposing major surfaces;
a layer of a second material on at least one of the opposing major surfaces of the second nanofiber sheet, the second material having a negative triboelectric affinity; and
a resilient connection between the first triboelectric element and the second triboelectric element,
wherein the layer of the first material of the first triboelectric element and the layer of the second material of the second triboelectric element are opposed to one another.

2. The set of triboelectric elements of claim 1, wherein the resilient connection between the first triboelectric element and the second triboelectric element comprises a spring at a first common end of the first triboelectric element and the second triboelectric element.

3. The set of triboelectric elements of claim 2, further comprising a pivot structure at a second comment end of the first triboelectric element and the second triboelectric element opposite the first common end.

4. The set of triboelectric elements of claim 3, wherein the pivot structure comprises a hinge.

5. The set of triboelectric elements of claim 1, further comprising an electrically conductive material disposed within at least one of the first nanofiber sheet and the second nanofiber sheet.

6. The set of triboelectric elements of claim 5, wherein the electrically conductive material is disposed in gaps between nanofibers within the first nanofiber sheet and the second nanofiber sheet.

7. The set of triboelectric elements of claim 5, wherein the electrically conductive material is poly(3,4-ethylenedioxythiophene) polystyrene sulfonate.

8. The set of triboelectric elements of claim 7, wherein the poly(3,4-ethylenedioxythiophene) polystyrene sulfonate is sulfuric acid modified poly(3,4-ethylenedioxythiophene) polystyrene sulfonate.

9. A triboelectric element comprising:
a nanofiber sheet having two opposite major surfaces; and
a material having a triboelectric affinity disposed on at least one of the major surfaces.

10. The triboelectric element of claim 9, wherein the material having a triboelectric affinity is a first material having a positive triboelectric affinity.

11. The triboelectric element of claim 9, wherein the material having a triboelectric affinity is a second material having a negative triboelectric affinity.

12. The triboelectric element of claim 9, further comprising an electrically conductive material disposed between nanofibers within the nanofiber sheet.

13. The triboelectric element of claim 12, wherein the electrically conductive material is poly(3,4-ethylenedioxythiophene) polystyrene sulfonate.

14. The triboelectric element of claim 13, wherein the poly(3,4-ethylenedioxythiophene) polystyrene sulfonate is sulfuric acid modified poly(3,4-ethylenedioxythiophene) polystyrene sulfonate.

15. A triboelectric generator assembly comprising:
a first set of triboelectric elements, the first set comprising:
a first triboelectric element that includes a first nanofiber sheet having opposing major surfaces, a layer of a first material on at least one of the opposing major surfaces of the first nanofiber sheet, the first material having a positive triboelectric affinity;
a second triboelectric element that includes a second nanofiber sheet having opposing major surfaces, a layer of a second material on at least one of the opposing major surfaces of the second nanofiber sheet, the second material having a negative triboelectric affinity;
a resilient connection between the first triboelectric element and the second triboelectric element, wherein
the first triboelectric element and the second triboelectric element are configured so that the layer of the first material in the layer of the second material are configured to be brought into reversible contact with one another; and
a second set of triboelectric elements, the second set comprising:
a third triboelectric element that includes a third nanofiber sheet having opposing major surfaces, a layer of the first material on at least one of the opposing major surfaces of the third nanofiber sheet;
a fourth triboelectric element that includes a fourth nanofiber sheet having opposing major surfaces, a layer of the second material on at least one of the opposing major surfaces of the fourth nanofiber sheet; and
a resilient connection between the third triboelectric element and the fourth triboelectric element, wherein
the third triboelectric element and the fourth triboelectric element are configured so that the layer of the first material and the layer of the second material are configured to be brought into reversible contact with one another, and
wherein the second triboelectric element and the third triboelectric element are configured to be brought into reversible contact with one another.

16. The triboelectric generator assembly of claim 15, further comprising a frame connected to the triboelectric generator assembly.

17. The triboelectric generator assembly of claim 16, wherein the frame includes:
a top plate connected to the fourth triboelectric element;
a bottom plate connected to the first triboelectric element; and
at least one spring connected to the top and the bottom plates and providing a force urging the top plate and the bottom plate apart.

18. The triboelectric generator assembly of claim 15, wherein the first, second, third, and fourth triboelectric elements are in contact with adjacent triboelectric elements when the triboelectric generator assembly is in a compressed state.
